(19) United States
(12) Patent Application Publication
(10) Pub. No.: US 2024/0284260 A1
(43) Pub. Date: Aug. 22, 2024

(54) WIRELESS NETWORK SLICE BROKERING

(71) Applicant: T-MOBILE INNOVATIONS LLC, Overland Park, KS (US)

(72) Inventors: Marouane Balmakhtar, Fairfax, VA (US); Lyle Walter Paczkowski, Mission Hills, KS (US)

(21) Appl. No.: 18/171,110

(22) Filed: Feb. 17, 2023

(51) Int. Cl. H04W 28/18

(52) U.S. Cl. CPC H04W 28/18; H04W 84/042

(57) ABSTRACT

A wireless communication system serves a wireless user device with network slices. The wireless communication system receives a slice request for the wireless user device and selects network slices for the wireless user device in response to the slice request. The wireless communication system transfers a slice response that has slice information to initiate control-planes and user-planes for the wireless user device based on the selected network slices. The wireless communication system transfers user data for the wireless user device over the user-planes under control of the control-planes.

### TECHNICAL BACKGROUND

Wireless communication systems provide wireless data services to wireless user devices like serving internet-access to phones and computers. The wireless user devices execute user applications that consume the wireless data services. For example, a user computer may execute a social-networking application that communicates with a content server over a wireless communication system.

The wireless communication systems have wireless access nodes that exchange wireless signals with the wireless user devices over wireless communication links. The wireless access nodes also exchange this user data with user-plane elements like User Plane Functions (UPFs) and data gateways that are often connected to the internet. The user-plane elements are directed by control-plane elements like Session Management Functions (SMFs) and Policy Control Functions (PCFs). The SMFs and PCFs control that data services that are delivered to the wireless user devices.

The user-plane elements and the control-plane elements may form network slices. The network slices are typically optimized for a specific type of data transaction. For example, an SMF and UPF may form a network slice that specializes in low-latency data transfers. To use a network slice, a wireless user device transfers a slice request to its control-plane. The control-plane includes a Network Slice Selection Function (NSSF) that processes the slice request and identifies the specific slice instance for the wireless user device. For example, a wireless user device may request a slice type for media-downloading, and the NSSF would select a specific slice instance that includes an SMF and UPF that are optimized to serve media-downloads to the wireless user device.

The network slices are deployed within individual wireless communication systems that are referred to as Public Land Mobile Networks (PLMNs). Thus, a given network slice exists within a single PLMN. Unfortunately, the network slices in one PLMN are not effectively integrated with the network slices in another PLMN. Moreover, the network slices are not efficiently implemented with user-planes and control planes that cross PLMN boundaries. In addition, the network slices are not properly deployed externally to PLMNs.

### TECHNICAL OVER VIEW

In some examples, a wireless communication system serves a wireless user device with network slices. The wireless communication system receives a slice request for the wireless user device and selects network slices for the wireless user device in response to the slice request. The wireless communication system transfers a slice response that indicates the selected network slices. The wireless communication system initiates control-planes and user-planes for the wireless user device based on the selected network slices. The wireless communication system transfers user data for the wireless user device over the user-planes under control of the control-planes.

In some examples, a wireless communication system serves a wireless user device with multiple network slices. In the wireless communication system, a network slice broker receives a slice request for the wireless user device. The network slice broker selects network slices for the wireless user device in response to the slice request. The network slice broker indicates the selected network slices for the wireless user device to Network Slice Selection

Functions (NSSFs). The NSSFs initiate control-planes and user-planes for the wireless user device based on the network slices. The user-planes transfer user data for the wireless user device in response to signaling from the control-planes.

### DESCRIPTION OF THE DRAWINGS

FIG. 1 illustrates an exemplary wireless communication system that brokers and uses wireless network slices to serve a wireless user device.

FIG. 2 illustrates an exemplary operation of the wireless communication system to broker and use the wireless network slices to serve the wireless user device.

FIG. 3 illustrates an exemplary operation of the wireless communication system to broker and use the wireless network slices to serve the wireless user device.

FIG. 4 illustrates an exemplary wireless communication system to broker and use wireless network slices across Public Land Mobile Networks (PLMNs) to serve a wireless User Equipment (UE).

FIG. 5 illustrates an exemplary wireless UE in the wireless communication system.

FIG. 6 illustrates an exemplary 5GNR Access Node (AN) in the wireless communication system.

FIG. 7 illustrates an exemplary data center in the wireless communication system.

FIG. 8 illustrates an exemplary operation of the wireless communication system to broker and use the wireless network slices across the PLMNs to serve the wireless UE.

FIG. 9 illustrates an exemplary wireless communication system to broker and use wireless network slices to serve a vehicle.

### DETAILED DESCRIPTION

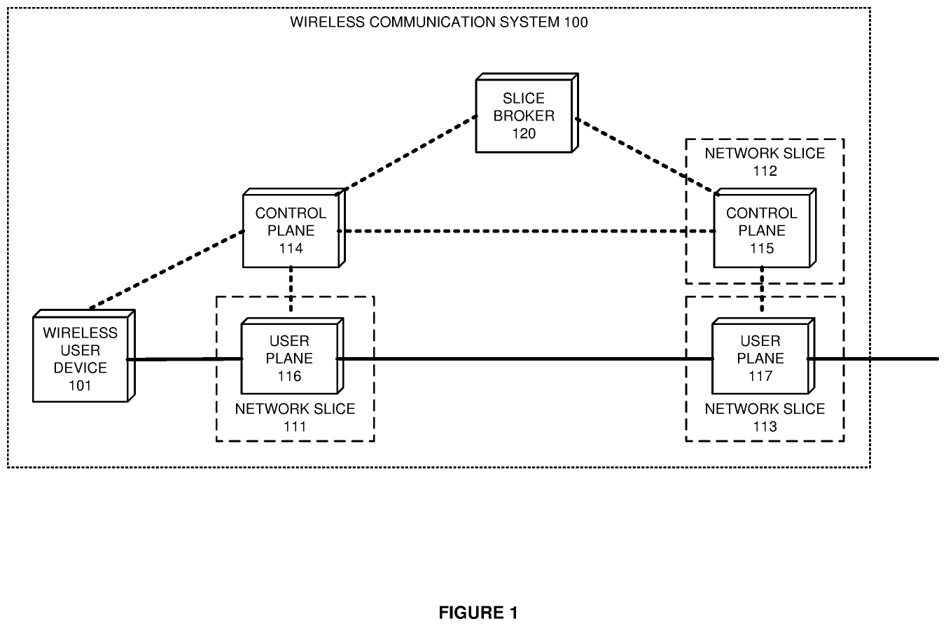

FIG. 1 illustrates exemplary wireless communication system 100 that brokers and uses network slices 111-113 to serve wireless user device 101. Wireless communication system 100 comprises wireless user device 101, network slices 111-113, control-plane 114, and slice broker 120. Network slice 111 comprises user-plane 116. Network slice 112 comprises control-plane 115. Network slice 113 comprises user-plane 117.

Various examples of system operation and configuration are described herein. In some examples, wireless communication system 100 serves wireless user device 101 with network slices 111-113. Slice broker 120 receives a slice request from wireless user device 101 over control-plane 114. Slice broker 120 selects network slices 111-113 for wireless user device 101 in response to the slice request. Slice broker 120 transfers a slice response that indicates the selected network slices to control-plane 114. Control-plane 114 instantiates control-plane 115 and user-planes 116-117 for wireless user device 101 based on the slice response. Thus, slice broker 120 initiates control-plane 115 and user-planes 116-117 to serve wireless user device 101 based on selected network slices 111-113. Wireless user device 101 transfers user data over user-planes 116-117 under control of control-planes 114-115.

In some examples, control-planes 114-115 are in different Public Land Mobile Networks (PLMNs). In some examples, user-planes 116-117 are in different PLMNs. At least some of control-planes 114-115 and user-planes 116-117 may not be in any PLMN. In some examples, wireless user device 101 transfers the slice request to control-plane 114 and slice broker 120 in User Equipment (UE) capability information. In some examples, slice broker receives the slice request from a Network Slice Selection Function (NSSF) in control-plane 114.

Advantageously, slice broker 120 effectively and efficiently integrates network slices 111-113 to serve wireless user device 101. Moreover, network slices 111-113 may cross PLMN boundaries or be deployed externally to PLMNs altogether.

Wireless user device 101 comprises a computer, phone, controller, and/or some other user apparatus with communication circuitry. Network slices 111-113 comprise control-plane 115 and user planes 116-117. User-planes 116-117 comprise network elements that handle user data. Exemplary user-plane network elements comprise User Plane Functions (UPFs), wireless access nodes, application servers, data gateways, and/or some other network apparatus with data communication circuitry. Control-planes 114-115 comprise network elements that control user planes 116-117. Exemplary control-plane network elements comprise Access and Mobility Management Functions (AMFs), Session Management Functions (SMFs), Policy Control Functions (PCFs), Network Slice Selection Functions (NSSFs), Unified Data Management (UDMs), Network Exposure Functions (NEFs), and/or some other network apparatus with data processing circuitry. Slice broker 120 comprises a control-plane network element. An exemplary slice broke comprises a Network Function (NF), control server, signaling processor, and/or some other network apparatus with control circuitry.

Wireless user device 101 and user-plane 116 comprise radios that wirelessly communicate using wireless protocols like Institute of Electrical and Electronics Engineers 802.11 (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and Sixth Generation (6G) satellite communications. Wireless user device 101, control-planes 114-115, user-planes 116-117, and slice broker 120 comprise microprocessors, software, memories, transceivers, bus circuitry, and/or some other data processing components, The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, applications, methods, and functions. The microprocessors retrieve the software from the memories and execute the software to drive the operation of wireless communication system 100 as described herein.

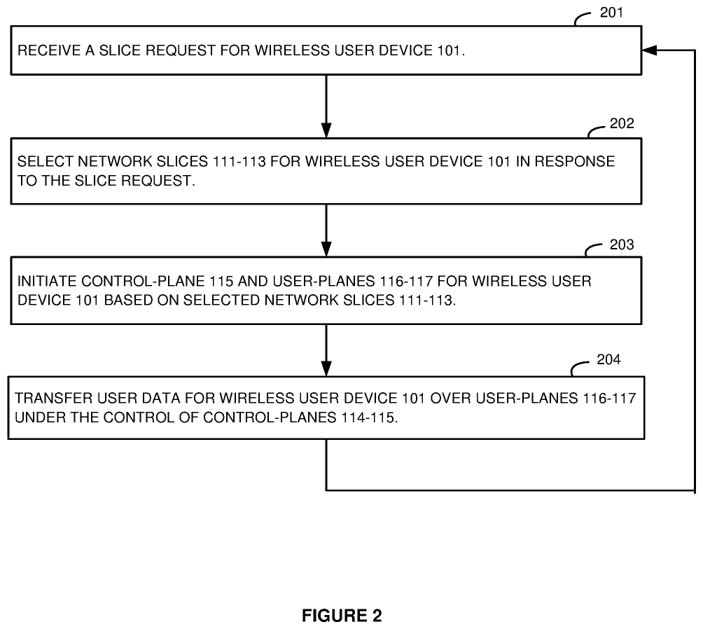

FIG. 2 illustrates an exemplary operation of wireless communication system 100 to broker and use wireless network slices 111-113 to serve wireless user device 101. The operation may vary in other examples. Wireless communication system 100 receives a slice request for wireless user device 101 (201). Wireless communication system 100 selects network slices 111-113 for wireless user device 101 in response to the slice request (202). Wireless communication system 100 initiates control-plane 115 and user-planes 116-117 for wireless user device 101 based on selected network slices 111-113 (203). Wireless communication system 100 transfers user data for wireless user device 101 over user-planes 116-117 under the control of control-planes 114-115 (204).

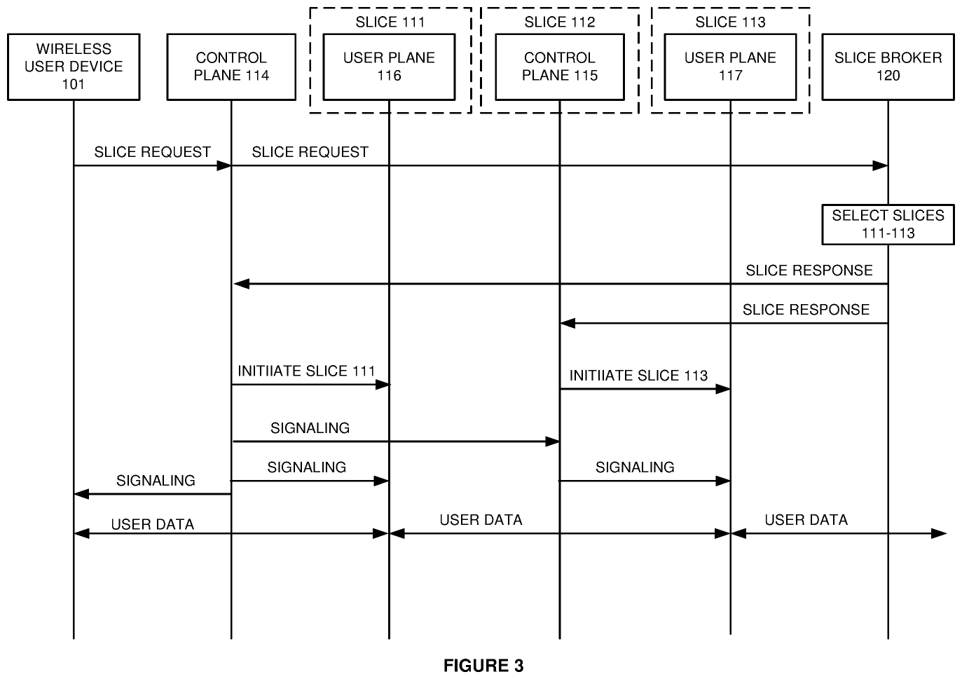

FIG. 3 illustrates an exemplary operation of wireless communication system 100 to broker and use wireless network slices 111-112 to serve wireless user device 101. The operation may vary in other examples. Wireless user device 101 transfers a slice request to control-plane 114. Control-plane 114 transfers the slice request to slice broker 120. Slice broker 120 selects network slices 111-113 for wireless user device 101 in response to the slice request. Slice broker 120 signals slice responses having slice instantiation and slice information to control-planes 114-115. Control-plane 114 initiates user-plane 116 in network slice 111. Control-plane 115 initiates user-plane 117 in network slice 113. Control-plane 114 signals context for wireless user device 101 to control-plane 115 in slice 112. Control-plane 114 signals context for wireless user device 101 to user-plane 116 in slice 111. Control-plane 115 in slice 112 signals context for wireless user device 101 to user-plane 117 in slice 113. Control-plane 114 signals context for wireless user device 101 to wireless user device 101. Wireless user device 101 exchanges user data with user-plane 116 in slice 111 in response to the context. User-plane 116 in slice 111 exchanges the user data with user-plane 117 in slice 113 in response to the context. User-plane 117 in slice 113 exchanges the user data with external systems in response to the context.

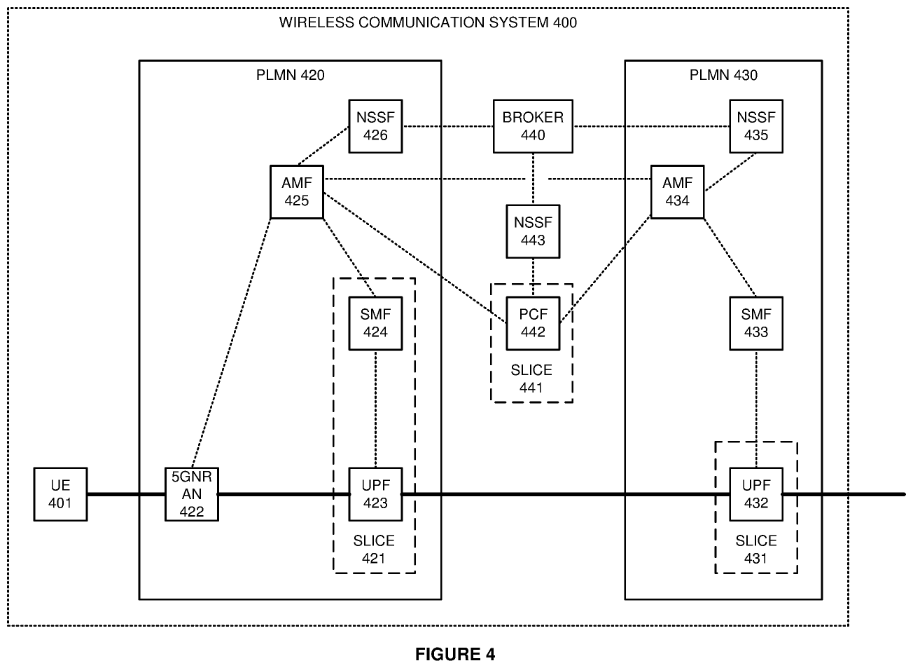

FIG. 4 illustrates exemplary wireless communication system 400 to broker and use wireless network slices 421, 431, and 441 across Public Land Mobile Networks (PLMNs) 420 and 430 to serve wireless User Equipment (UE) 401. Wireless communication system 400 comprises an example of wireless communication system 100, although wireless communication system 100 may differ. Wireless communication system 400 comprises UE 401, PLMN 420, PLMN 430, broker 440, slice 441 and Network Slice Selection Function (NSSF) 443. PLMN 420 comprises slice 421, 5GNR Access Node (AN) 422, Access and Mobility Management Function (AMF) 425, and NSSF 426. PLMN 430 comprises slice 431, SMF 433, AMF 434, and NSSF 435. Slice 421 comprises User Plane Function (UPF) 423 and Session Management Function (SMF) 424. Slice 431 comprises UPF 432. Slice 441 comprises Policy Control Function (PCF) 442.

AMFs 425 and 434 include the following functionality: termination of control-pane interface (N2) to Radio Access Networks (RANs), termination of Non-Access Stratum (NAS) interface N1 to UEs, UE registration management, UE connection management, UE reachability management, UE mobility management, lawful intercept, transport for N1 messages between UEs and SMFs, UE authentication, UE authorization, security anchor functionality, location services management, bearer ID allocation, UE event notification, and non-5GNR access. SMFs 424 and 433 include the following functionality: session establishment, session modification and release, tunneling between AN and UPF, UE address allocation, address resolution protocol requests, user-plane control, UPF traffic steering, virtual network management, PCF interface termination, lawful intercept, charging data collection, termination of NAS messages, downlink data notification, session mode determination, and header compression support. UPFs 423 and 432 include the following functionality: mobility anchor point, UE address/prefix allocation, external point of interconnect, packet routing and forwarding, packet inspection, uplink traffic verification, packet marking, packet buffering, address resolution protocol requests, packet duplication and elimination, and data steering. PCF 442 includes the following functionality: unified policy framework to control network operations, policy rules for control-planes, and policy decisions for Unified Data Repositories (UDRs). NSSFs 426, 435, and 443 support the following functionality: selecting network slice instances, determining Network Slice Selection Assistance Information (NSSAI), and determining AMF candidates.

Broker 440 receives slice registrations for various NFs like UPFs, PCFs, and SMFs. The registrations include information for the NFs like capabilities and features for various slice types. The registrations also indicate other NFs in their network or PLMN - like associated AMFs, NSSFs, and SMFs. Broker 440 has data structures to translate slice types and/or slice selection information into selected slices. Broker 440 may also consider UE location and UE ID when selecting slices. UE IDs comprise Cell Radio Network Temporary Identifier (C-RNTI), Permanent Equipment Identifier (PEI), or some other data that indicates the UE 401.

In operation, UPF 423 in slice 421 registers with NSSF 426, and NSSF 426 registers UPF 423 in slice 421 with broker 440. PCF 442 in slice 441 registers with NSSF 443, and NSSF 443 registers PCF 442 in slice 441 with broker 440. UPF 423 and SMF 424 in slice 421 register with NSSF 426, and NSSF 426 registers UPF 423 and SMF 424 in slice 421 with broker 440. UPF 432 in slice 431 registers with NSSF 435, and NSSF 435 registers UPF 432 in slice 431 with broker 440.

UE 401 transfers UE capability information that includes a slice type and/or slice selection information to AMF 425 over 5GNR AN 422. AMF 425 transfers a slice request (RQ) for UE 401 that includes the requested slice type and/or slice selection information to NSSF 426. NSSF 426 transfers the slice request for UE 401 that includes the requested slice type and/or slice selection information to broker 440. Based on the slice type and/or slice selection information, broker 440 selects slices 421, 431, and 441. Broker 440 transfer a slice response having slice information for selected slices 421, 431, and 441 to NSSFs 426, 443, and 435. NSSF 426 transfers the slice information for selected slices 421, 431, and 441 to AMF 425. NSSF 443 transfers the slice information for selected slices 421, 431, and 441 to PCF 442. NSSF 435 transfers the slice information for selected slices 421, 431, and 441 to UPF 432.

Based on the slice information, AMF 425 transfers a policy request (RQ) to PCF 442, and PCF 442 responds with policy information for UE 401. For example, the policy information may specify service quality for UE 401 based on location and/or time. Based on the slice information, AMF 425 transfers a service request to AMF 434, and AMF 434 responds with context for UPF 432. Based on the slice information, AMF 425 signals context to SMF 424 in slice 421, and SMF 424 signals UPF 423 with context for UE 401 and UPF 432. Based on the signaling from AMF 425, AMF 434 signals context to SMF 433, and SMF 433 signals UPF 432 with context for UPF 423 and possibly for external systems. AMF 425 signals context to UE 401.

Based on the signaling, UE 401 exchanges user data with UPF 423 over 5GNR AN 422. Based on the signaling, UPF 423 exchanges the user data with 5GNR AN 422 and with UPF 432. Based on the signaling, UPF 432 exchanges the user data with UPF 423 and with external systems like the internet.

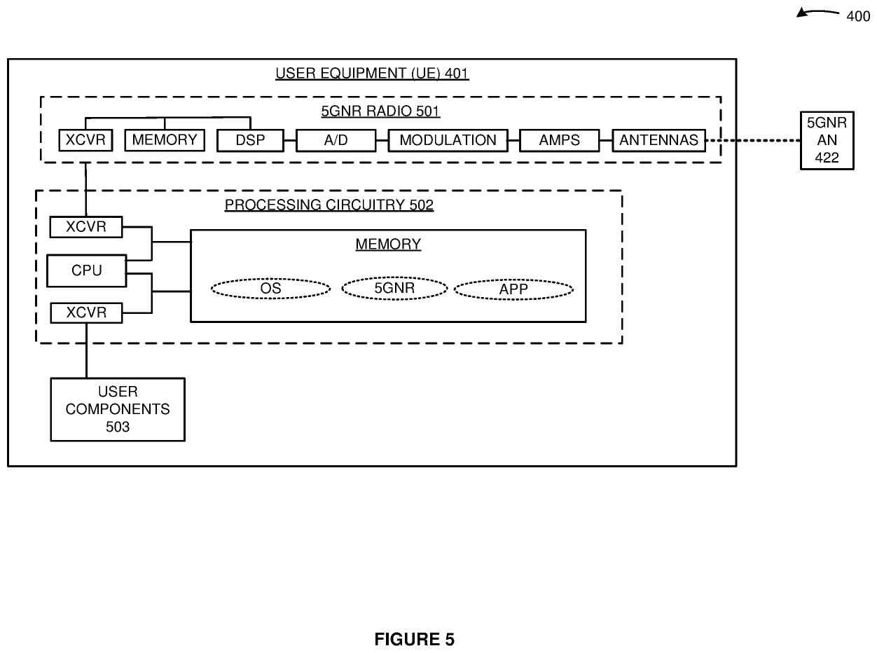

FIG. 5 illustrates exemplary UE 401 in wireless communication system 400. UE 401 represents an example of wireless user device 101, although device 101 may differ. UE 401 comprises 5GNR radio 501, processing circuitry 502, and user components 503. Radio 501 comprises antennas, amplifiers, filters, modulation, analog-to-digital interfaces, DSP, memory, and transceivers that are coupled over bus circuitry. Processing circuitry 502 comprises CPU, memory, and transceivers (XCVRs) that are coupled over bus circuitry. The memory in processing circuitry 502 stores software like an Operating System (OS), 5GNR application (5GNR), and user applications (APP). User components 503 comprise displays, sensors, controllers, and/or some other user apparatus. The antennas in 5GNR radio 501 exchange 5GNR signals with 5GNR AN 422. A transceiver in radio 501 is coupled to a transceiver in processing circuitry 502. A transceiver in processing circuitry 502 is coupled to user components 503. In processing circuitry 502, the CPU retrieves the software from the memory and executes the software to direct the operation of UE 401 as described herein.

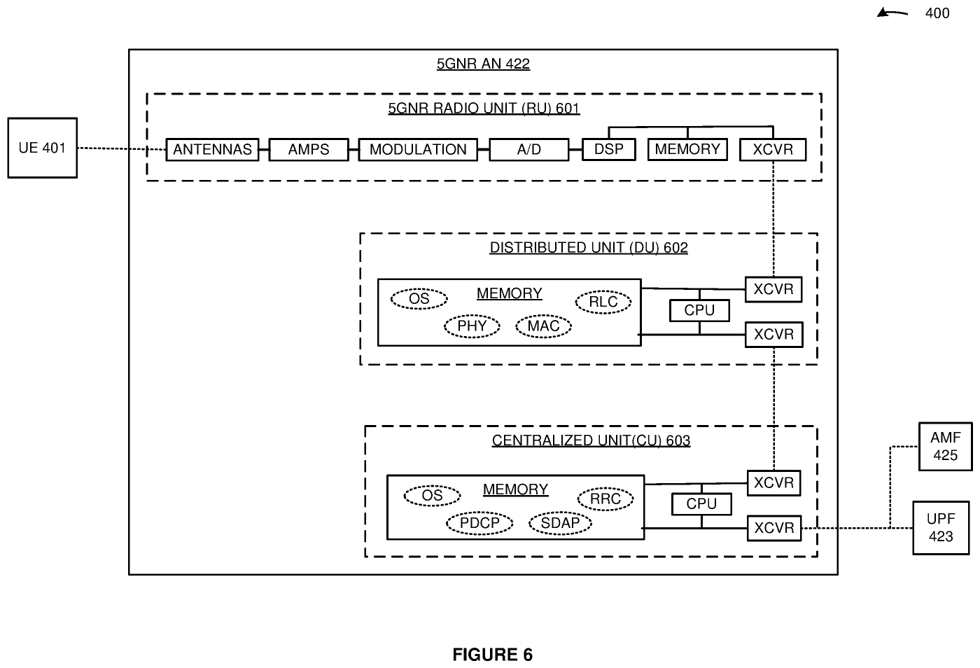

FIG. 6 illustrates exemplary 5GNR AN 422 in wireless communication system 400. 5GNR AN 422 comprises and example of user-plane 116, although user-plane 116 may differ. 5GNR AN 422 comprises 5GNR Radio Unit (RU) 601, Distributed Unit (DU) 602, and Centralized Unit (CU) 603. 5GNR RU 601 comprises antennas, amplifiers, filters, modulation, analog-to-digital interfaces, DSP, memory, radio applications, and transceivers that are coupled over bus circuitry. DU 602 comprises memory, CPU, user interfaces and components, and transceivers that are coupled over bus circuitry. The memory in DU 602 stores operating system and 5GNR network applications for Physical Layer (PHY), Media Access Control (MAC), and Radio Link Control (RLC). CU 603 comprises memory, CPU, and transceivers that are coupled over bus circuitry. The memory in CU 603 stores an operating system and 5GNR network applications for Packet Data Convergence Protocol (PDCP), Service Data Adaption Protocol (SDAP), and Radio Resource Control (RRC). The antennas in 5GNR RU 601 are wirelessly coupled to UE 401 over 5GNR links. Transceivers in 5GNR RU 601 are coupled to transceivers in DU 602. Transceivers in DU 602 are coupled to transceivers in CU 603. Transceivers in CU 603 are coupled AMF 425 and UPF 423. The DSP and CPU in RU 601, DU 602, and CU 603 execute the radio applications, operating systems, and network applications to exchange data and signaling with UE 401, AMF 425, and UPF 423 as described herein.

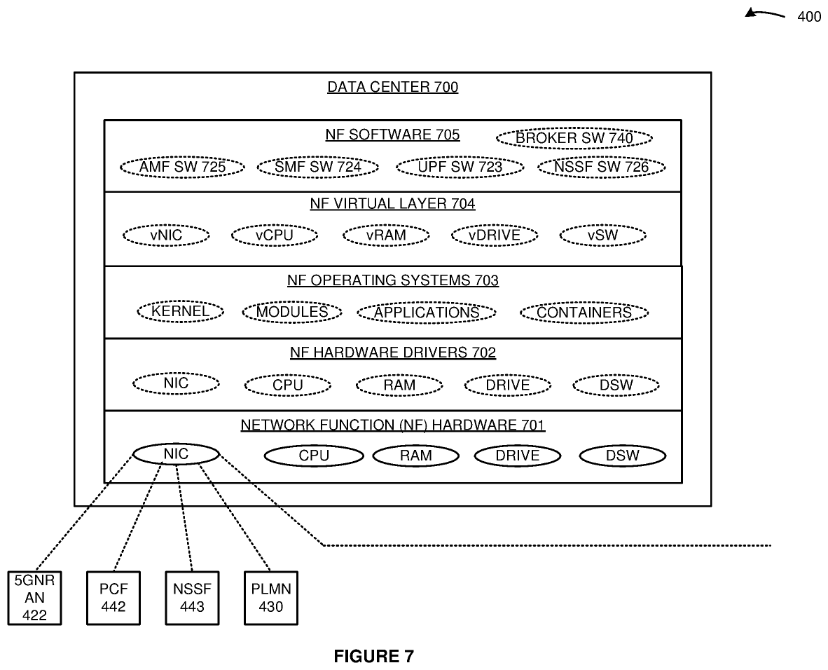

FIG. 7 illustrates exemplary data center 700 in wireless communication system 400. Network data center 700 comprises an example of control-planes 114-115, user-planes 116-117, and slice broker 120, although these network elements may differ. Network data center 700 comprises NF hardware 701, NF hardware drivers 702, NF operating systems 703, NF virtual layer 704, and NF Software (SW) 705. NF hardware 701 comprises Network Interface Cards (NICs), CPU, RAM, Flash/Disk Drives (DRIVE), and Data Switches (DSW). NF hardware drivers 702 comprise software that is resident in the NIC, CPU, RAM, DRIVE, and DSW. NF operating systems 703 comprise kernels, modules, applications, and containers. NF virtual layer 704 comprises vNIC, vCPU, vRAM, vDRIVE, and vSW. NF SW 705 comprises AMF SW 725, SMF SW 724, UPF SW 723, NSSF SW 726, and broker SW 740. The NIC in NF hardware 701 are coupled to 5GNR AN 422, PCF 442, NSSF 443, PLMN 430, and external systems. NF hardware 701 executes NF hardware drivers 702, NF operating systems 703, NF virtual layer 704, and NF SW 705 to form and operate AMF 425, SMF 424, UPF 423, NSSF 426, and broker 440 as described herein. Network data center 700 may be located at a single site or be distributed across multiple geographic locations. Data centers for PLMN 430, PCF 442, and NSSF 443 could be configured in a like manner to data center 700.

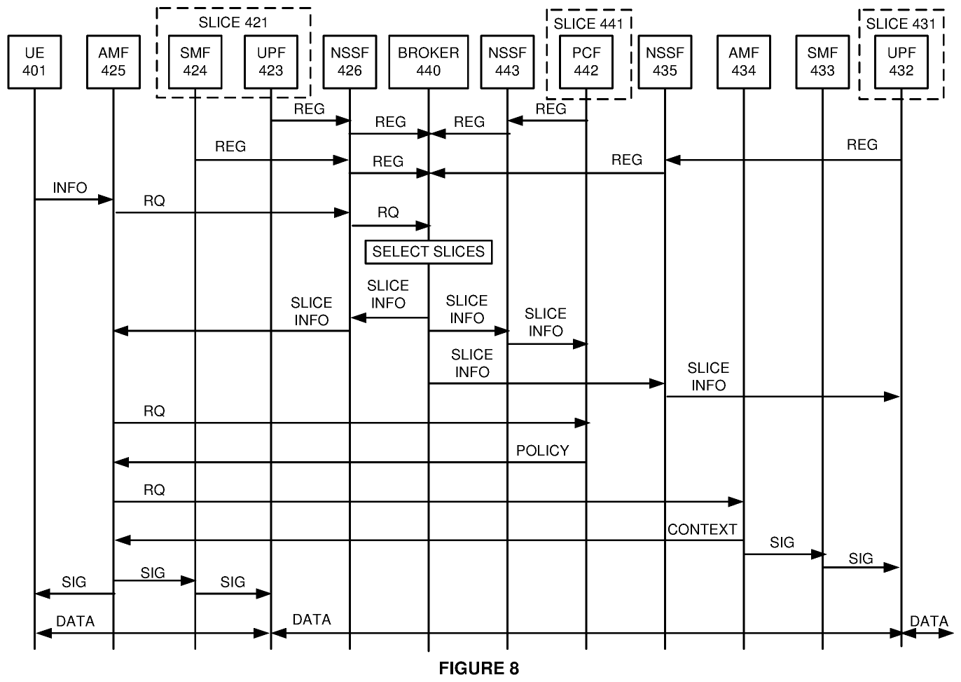

FIG. 8 illustrates an exemplary operation of wireless communication system 400 to broker and use wireless network slices 421, 431, and 441 across PLMNs 420 and 430 to serve wireless UE 401. The operation may differ in other examples. UPF 423 in slice 421 registers with NSSF 426, and NSSF 426 registers UPF 423 in slice 421 with broker 440. PCF 442 in slice 441 registers with NSSF 443, and NSSF 443 registers PCF 442 in slice 441 with broker 440. SMF 424 in slice 421 registers with NSSF 426, and NSSF 426 registers SMF 424 in slice 421 with broker 440. UPF 432 in slice 431 registers with NSSF 435, and NSSF 435 registers UPF 432 in slice 431 with broker 440.

UE 401 transfers UE capability information (INFO) that includes a slice type and/or slice selection information to AMF 425. AMF 425 transfers a slice request (RQ) for UE 401 that includes the requested slice type and/or slice selection information to NSSF 426. NSSF 426 transfers the slice request for UE 401 that includes the requested slice type and/or slice selection information to broker 440. Based on the slice type and/or slice selection information, broker 440 selects slices 421, 431, and 441. Broker 440 transfers a slice response having slice information for selected slices 421, 431, and 441 to NSSFs 426, 443, and 435. NSSF 426 transfers the slice information for selected slices 421, 431, and 441 to AMF 425. NSSF 443 transfers the slice information for selected slices 421, 431, and 441 to PCF 442. NSSF 435 transfers the slice information for selected slices 421, 431, and 441 to UPF 432.

Based on the slice information, AMF 425 transfers a policy request (RQ) to PCF 442, and PCF 442 responds with policy information for UE 401. Based on the slice information, AMF 425 transfers a service request to AMF 434, and AMF 434 responds with context for UPF 432. Based on the slice information, AMF 425 signals context to SMF 424 in slice 421, and SMF 424 signals UPF 423 with context for UE 401 and UPF 432. Based on the signaling from AMF 425, AMF 434 signals context to SMF 433, and SMF 433 signals UPF 432 with context for UPF 423 and possibly for external systems. AMF 425 signals context to UE 401.

Based on the signaling, UE 401 exchanges user data with UPF 423 over 5GNR AN 422 (which is omitted from FIG. 8 for clarity). Based on the signaling, UPF 423 exchanges the user data with UE 401 over 5GNR AN 422 and with UPF 432. Based on the signaling, UPF 432 exchanges the user data with UPF 423 and with external systems like the internet.

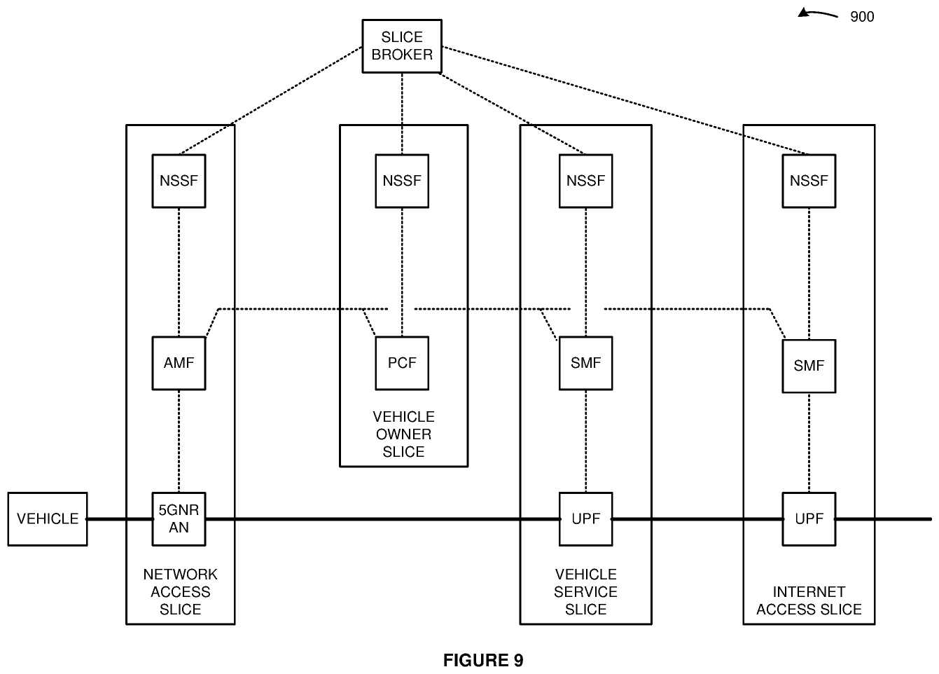

FIG. 9 illustrates exemplary wireless communication system 900 to broker and use wireless network slices to serve a vehicle. Wireless communication system 900 comprises an example of wireless communication systems 100 and 400, although systems 100 and 400 may differ. Wireless communication system 900 comprises a network access slice, vehicle owner slice, vehicle service slice, and an internet access slice. The network access slice comprises an NSSF, AMF, and 5GNR AN—and typically other NFs which are omitted for clarity. The vehicle owner slice comprises an NSSF and PCF—and possibly other NFs which are omitted for clarity. The internet access slice comprises an NSSF, SMF, and UPF—and typically other NFs which are omitted for clarity.

In the network access slice, the AMF registers with its NSSF and indicates context for the 5GNR AN. The NSSF in the network access slice registers with the slice broker. In the vehicle owner slice, the PCF registers with its NSSF which registers the vehicle owner slice with the slice broker. In the vehicle service slice, the SMF and UPF register with their NSSF, and the NSSF registers the vehicle service slice with the slice broker. In the internet access slice, the SMF and UPF register with their NSSF, and the NSSF registers the internet access slice with the slice broker.

The slice broker maintains a data structure that associates a slice identifier for the vehicle with the network access slice, vehicle owner slice, vehicle service slice, and internet access slice. The data structure associates the slice inter-connectivity as indicated on FIG. 9.

The vehicle requests the slice identifier from the 5GNR AN in the network access slice—typically through UE capability information. The 5GNR AN in the network access slice indicates the slice identifier for the vehicle to the AMF in the network access slice. The AMF in the network access slice indicates the slice identifier for the vehicle to the NSSF in the network access slice. The NSSF the network access slice indicates the slice identifier for the vehicle to the slice broker.

The slice broker translates the slice identifier from the vehicle into the network access slice, vehicle owner slice, vehicle service slice, and internet access slice—including the slice inter-connectivity indicated on FIG. 9. The slice broker signals the NSSFs in the selected slices with this slice information. The NSSFs signal the NFs (AMF, PCF, and SMF, and UPF) in the selected slices with this slice information.

The AMF in the network access slice signals UE context to the vehicle and 5GNR AN. The AMF in the network access slice retrieves policy for the vehicle from the PCF in the vehicle owner slice. For example, the policy may limit the geographic area permitted to the vehicle based on the date. Per the policy, the AMF in the network access slice signals UE context to the SMF in the vehicle service slice. The SMF in the vehicle service slice signals UE context to the UPF in the vehicle service slice. Per the policy, the AMF in the network access slice signals UE context to the SMF in the internet access slice. The SMF in the internet access slice signals UE context to the UPF in the internet access slice.

The vehicle exchanges vehicle data with the 5GNR AN in the network access slice based on the UE context. The 5GNR AN in the network access slice exchanges vehicle data with the UPF in the vehicle service slice based on the UE context. Some of the vehicle data is consumed by the vehicle service slice to maintain the vehicle like scheduling a replacement of parts based on an alarm, milage, and the like. The UPF in the vehicle service slice exchanges vehicle data with the UPF in the internet access slice based on the UE context. The UPF in the internet access slice exchanges vehicle data with the internet based on the UE context.

The wireless communication system circuitry described above comprises computer hardware and software that form special-purpose circuitry to broker and use wireless network slices to serve wireless user devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, methods, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose circuitry to broker and use wireless network slices to serve wireless user devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method to serve a wireless user device with network slices, the method comprising:
receiving a slice request for the wireless user device;
selecting network slices for the wireless user device in response to the slice request;
transferring a slice response that indicates the selected network slices;
wherein control-planes and user-planes are initiated for the wireless user device based on the selected network slices; and
wherein user data is transferred for the wireless user device over the user-planes under control of the control-planes.

2. The method of claim 1 wherein the control-planes are in different Public Land Mobile Networks (PLMNs).

3. The method of claim 1 wherein the user-planes are in different Public Land Mobile Networks (PLMNs).

4. The method of claim 1 wherein at least one of the control-planes is not in a Public Land Mobile Network (PLMN).

5. The method of claim 1 wherein at least one of the user-planes is not in a Public Land Mobile Network (PLMN).

6. The method of claim 1 wherein receiving the slice request for the wireless user device comprises receiving User Equipment (UE) capability information having the slice request.

7. The method of claim 1 wherein receiving the slice request for the wireless user device comprises receiving the slice request from a Network Slice Selection Function (NSSF).

8. A method to serve a wireless user device with multiple network slices, the method comprising:
a network slice broker receiving a slice request for the wireless user device;
the network slice broker selecting network slices for the wireless user device in response to the slice request and indicating the selected network slices for the wireless user device to Network Slice Selection Functions (NSSFs);
the NSSFs initiating control-planes and user-planes for the wireless user device based on the network slices; and
the user-planes transferring user data for the wireless user device in response to signaling from the control-planes.

9. The method of claim 8 wherein the control-planes are in different Public Land Mobile Networks (PLMNs).

10. The method of claim 8 wherein the user-planes are in different Public Land Mobile Networks (PLMNs).

11. The method of claim 8 wherein at least one of the control-planes is not in a Public Land Mobile Network (PLMN).

12. The method of claim 8 wherein at least one of the user-planes is not in a Public Land Mobile Network (PLMN).

13. The method of claim 8 wherein the network slice broker receiving the slice request for the wireless user device comprises receiving User Equipment (UE) capability information having the slice request.

14. The method of claim 8 wherein the network slice broker receiving the slice request for the wireless user device comprises receiving the slice request from one of the NSSFs.

15. A wireless communication system to serve a wireless user device with multiple network slices, the wireless communication system comprising:
a network slice broker to receive a slice request for the wireless user device;
the network slice broker to select network slices for the wireless user device in response to the slice request and indicate the selected network slices for the wireless user device to Network Slice Selection Functions (NSSFs);
the NSSFs to initiate control-planes and user-planes for the wireless user device based on the network slices; and
the user-planes to transfer user data for the wireless user device in response to signaling from the control-planes.

16. The wireless communication system of claim 15 wherein the control-planes are in different Public Land Mobile Networks (PLMNs).

17. The wireless communication system of claim 15 wherein the user-planes are in different Public Land Mobile Networks (PLMNs).

18. The wireless communication system of claim 15 wherein at least one of the control-planes is not in a Public Land Mobile Network (PLMN).

19. The wireless communication system of claim 15 wherein at least one of the user-planes is not in a Public Land Mobile Network (PLMN).

20. The wireless communication system of claim 15 wherein the network slice broker is to receive User Equipment (UE) capability information having the slice request to receive the slice request for the wireless user device.
